(19) United States
(12) Patent Application Publication
(10) Pub. No.: US 2016/0296075 A1
(43) Pub. Date: Oct. 13, 2016

(54) Scooper knife/scooper knife adapter

(71) Applicant: RICKY D. RUSSELL, Lambertville, MI (US)

(72) Inventor: RICKY D. RUSSELL, Lambertville, MI (US)

(21) Appl. No.: 14/683,018

(22) Filed: Apr. 9, 2015

(51) Int. Cl. A47J 43/28

(52) U.S. Cl. CPC A47J 43/288

(57) ABSTRACT

The scooper knife has multi-purpose abilities, the scooper blade or the dull curved blade of the knife functions as a scooper of processed food. This is a combination one piece multi-purpose unit with a sharp blade or edge for cutting and processing food products and a dull blade or edge for scooping and transporting food products to there desired location. After cutting up or processing food products with the sharp blade of the knife, and depending on wither a person is left or right handed, either a left handed curved or right handed curved dull blade can be incorporated to scoop up and transport processed food products to a desired location. For example if a person is left handed a left handed scooper knife can be utilized with a curved dull blade that allows positioning of that blade flat on a cutting surface and then using the right hand to push the processed food up onto the scooper blade and transport to the desired location.

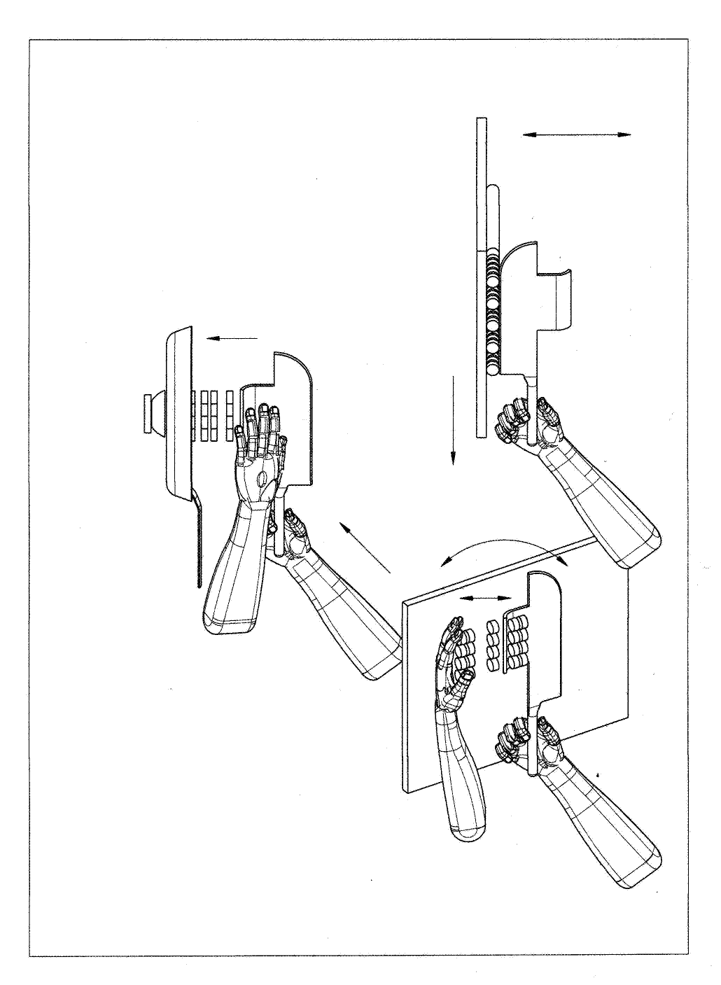

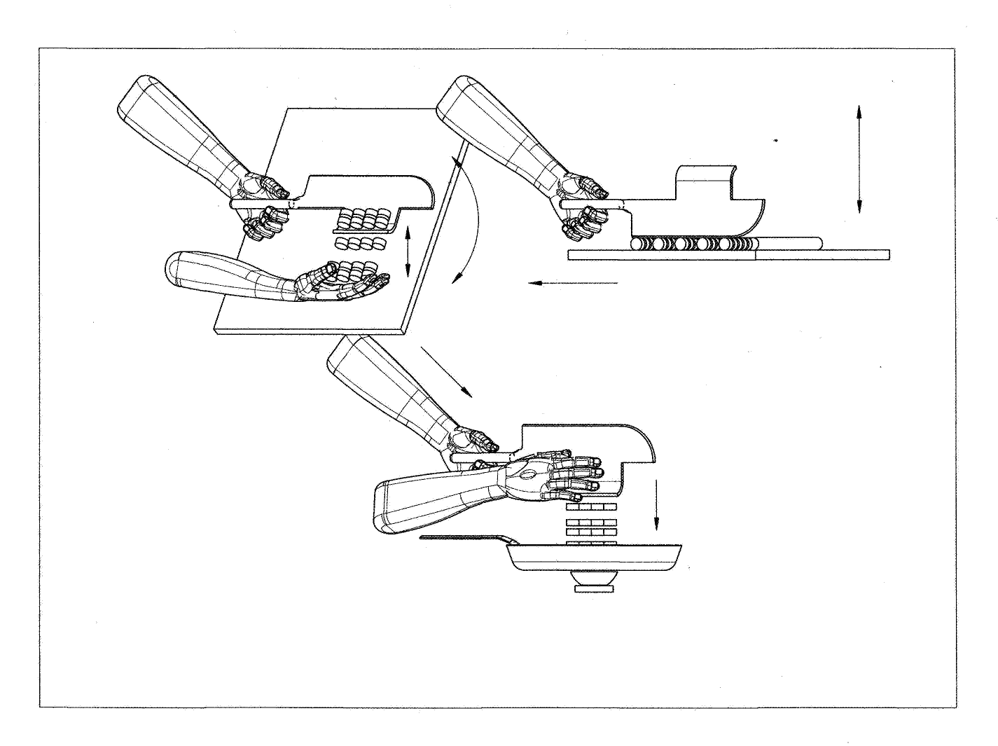

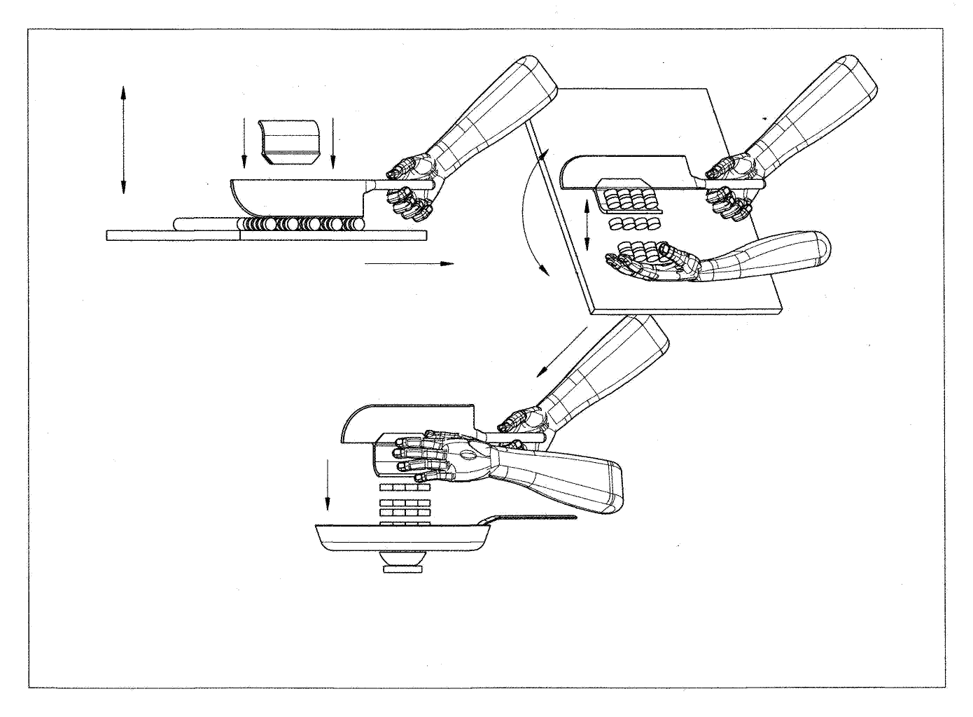

The scooper knife adapter allows a one piece knife to become a combination multi-purpose food processing knife. The curved dull or blade of the scooper knife adapter is a duel or reversible purpose blade, depending on wither a person is left or right handed and how a person places the adapter upon a dull edge of a cutting knife. If a person is left handed for example the adapter can be placed in a fashion so that the curved blade will be placed on the cutting surface to allow scooping up with the right hand the processed food product and transporting it to the desired location. The reverse is possible if a person is right handed the adapter can be placed on a cutting knife so that the curved blade will set on the cutting surface and scoop up the processed food with the left hand and transport to the desired location.

I Ricky D. Russell, have invented a scooper knife and scooper knife adapter for use in kitchens and restaurants. These knifes will help save time, money and the knifes cutting edge as will as transport food product during food processing.

### DESCRIPTION OF THE DRAWINGS

The application includes the following drawings of the new and useful nonprovisional utility invention:

Drawing 1 is; the right handed scooper knife, drawing 2 is; the left handed scooper knife, drawing 3 is; the reversible scooper knife adapter.

### SPECIFICATION

The scooper knife is a one piece combination knife, one edge is a dull transporting knife and the other edge is a sharp cutting knife. This knife will be made of food grade knife making material.

The scooper knife adapter with a dull straight transporting edge will accommodate the dull edge of a sharp cutting food processing knife. This knife will be made of food grade knife making material.

A scooper knife or scooper knife adapter is a fantastic food processing and transporting knife for use in kitchens and restaurants. It not only will save time but will save sharp cutting edges. You simply cut the food with the sharp edge and transport it with the dull edge of the knife.

The inspiration for the scooper knifes and adapter inventions came to me after watching cooking programs on pbs tv. The chefs use there food processing chefs knife to scoop up the processed food, also after processing the food they would set down the knife and grab another knife to scoop up the processed food. The scooper knife plus the scooper knife adapter saves time and the sharp edge of the knife plus transports food products.

### SPECIFICATION

The substitute specification contains no new matter.

1. I, Ricky D. Russell, claim the new and useful utility invention for a right handed scooper knife as shown in drawing 1.

2. I, Ricky D. Russell, claim the new and useful utility invention for a left handed scooper knife as shown in drawing 2.

3. I, Ricky D. Russell, claim the new and useful invention for a reversible scooper knife adapter as shown in drawing 3.
